(19) United States
(12) Patent Application Publication
(10) Pub. No.: US 2006/0193947 A1
(43) Pub. Date: Aug. 31, 2006

(54) Method for preparing a beverage

(76) Inventors: Sian Anderson, Hertfordshire (GB); Anthony J. Wilson, Hertfordshire (GB); Alberto Fissore, Cherasco (IT)

Correspondence Address: FITZPATRICK CELLA HARPER & SCINTO, 30 ROCKEFELLER PLAZA, NEW YORK, NY, 10112, US

(21) Appl. No.: 11/353,159

(22) Filed: Feb. 14, 2006

Related U.S. Application Data
(60) Provisional application No. 60/653,019, filed on Feb. 14, 2005.

(51) Int. Cl. C12C 11/00

(52) U.S. Cl. 426/11

(57) ABSTRACT

Distilled spirits are naturally carbonated using a fermentation process.

This application claims the benefit of U.S. Provisional Application No. 60/653,019, filed Feb. 14, 2005.

### BACKGROUND OF THE INVENTION

1. Field of the Invention

This invention relates to a method of naturally carbonating distilled spirits, as well as to certain alcoholic beverages containing natural effervescence.

2. Related Background Art

Imparting natural effervescence to alcoholic beverages is, to a certain degree, known. For example, natural effervescence is present in beverages such as champagne and sparkling wines. The effervescence therein is produced by way of a secondary fermentation process. In other words, a primary fermentation is carried out to achieve an initial alcohol content of typically 11% alcohol by volume, and then a secondary fermentation is carried out to impart effervescence or carbonation.

In champagne, such secondary fermentation is carried out in individual bottles which are then aged, then riddled and degorged to remove the yeast employed and finally dosed to achieve a desired flavor, etc., e.g., “methode champenoise”. In sparkling wines, such secondary fermentation can be carried out in pressurized tanks from which yeast is then filtered out and in which dosing also takes place, i.e., “methode charmat”. There are even known methods which employ a combination of such techniques, i.e., secondary fermentation and riddling in the bottle, but with dosage added in a pressurized tank, i.e., “transfer method”.

Heretofore natural effervescence has not been imparted to distilled spirits. This is most likely due to the fact that distilled spirits typically have a much higher alcohol content than what would be suitable in which to conduct a fermentation. However, the present inventors have now devised a method by which natural effervescence can be imparted to distilled spirits.

### SUMMARY OF THE INVENTION

The present invention is directed to a method for preparing an alcoholic beverage having natural effervescence, the method comprising the steps of (a) providing a distilled spirit having no more than about 30% alcohol by volume; (b) adding yeast and a fermentable carbohydrate to the distilled spirit to obtain a mixture; and (c) fermenting the mixture to provide the alcoholic beverage having natural effervescence. In preferred embodiments of the present invention, step (a) is accomplished by diluting a distilled spirit which has an alcohol by volume ranging from about 0.1% to about 100% or step (a) is accomplished by directly distilling a spirit having no more than about 30% alcohol by volume. In further preferred embodiments of this invention, the distilled spirit of step (a) has less than about 20% alcohol by volume.

In still other preferred embodiments, the yeast is provided in the form of a yeast broth which comprises yeast, optionally the fermentable carbohydrate or a portion thereof, optionally at least one nutrient and water. The fermentable carbohydrate may be provided in the mixture in an amount effective to achieve a desired degree of natural effervescence, preferably in an amount effective to provide an amount of fermentable carbohydrate in the mixture ranging from about 5 g/L to about 300 g/L prior to the fermenting step. The at least one nutrient may be selected from the group consisting of vitamins, minerals, ammonium phosphate, amino acids, and mixtures thereof. The yeast broth may also contain at least one fermentation facilitating ingredient selected from the group consisting of buffers, acidulants, and fining agents as desired.

In another preferred embodiment of the present invention, the pH of the mixture ranges from about 2.8 to about 5.5. In still other preferred embodiments of the invention, fermentation can be carried out for a period ranging from about I day to about 2 months and at a temperature ranging from about 5° C. to about 40° C. Fermentation is preferably carried out in a sealed container such as a bottle or pressure vessel such as a pressurized tank.

Further preferred embodiments of the present invention are those in which optional steps such as aging, yeast removal, and dosing are carried out.

The present invention is further directed to a naturally carbonated distilled spirit produced using the inventive fermentation method. In a preferred embodiment, the amount of natural effervescence ranges from about 2 g/L to about 14 g/L CO₂.

### DETAILED DESCRIPTION OF THE INVENTION

As noted above, the present inventors have devised a method by which natural effervescence can be imparted to distilled spirits. As used herein, “natural effervescence” refers to the presence of carbon dioxide generated from a fermentation process; such carbon dioxide is liberated from a given beverage upon the removal or discontinuance of some pressure-maintenance means. As used herein, “distilled spirit” refers to any alcohol-containing product that has been produced by a process which includes concentration of the alcohol by distillation or other similar process.

The first embodiment of the present invention is a method for preparing an alcoholic beverage having natural effervescence, said method comprising the steps of: (a) providing a distilled spirit having no more than about 30% alcohol by volume; (b) adding yeast and a fermentable carbohydrate to the distilled spirit to obtain a mixture; and (c) fermenting the mixture to provide the alcoholic beverage having natural effervescence. The order of addition, i.e., whether the yeast and fermentable carbohydrate are added to the distilled spirit or whether the distilled spirit is added to a yeast and fermentable carbohydrate, is not believed to be important.

The starting material for the present inventive method is any distilled spirit. The distilled spirit can be obtained commercially or manufactured by known distillation techniques. Suitable distilled spirits include, without limitation, vodka, gin, whisky, rum, cachaca, liquers, brandy, applejack, tequila, soju, arak, raki, flavored spirits, distilled spirit specialties, neutral spirit, and mixtures thereof. The starting material distilled spirit can have anywhere from about 0.1% to about 100% alcohol by volume. However, since the present invention is directed to natural carbonation, yeast is employed; typically yeast cannot function in an environment which has more than about 20-25% alcohol by volume.

Accordingly, an alcohol by volume content of no more than about 30%, preferably less than about 25%, more preferably less than about 20%, still more preferably from about 1% to less than about 20%, further still more preferably from about 3.5% to about 15%, and most preferably from about 8% to about 12%, can be achieved in the starting material distilled spirit in several different ways. First, a distilled spirit having any alcohol by volume content can be diluted with water to achieve the above-noted alcohol content. Such a dilution can be achieved by the simple addition of an amount of water or by any other suitable means. Alternatively, a distilled spirit having no more than about 30% alcohol by volume can be directly distilled, e.g., by allowing distillation to proceed so as to allow a desired amount of water to be included in the distillate. Other manners through which a distilled spirit having no more than about 30% alcohol by volume can be achieved can be envisioned, and this invention is not limited to the specific manners noted above. It should be noted that the alcohol content of the distilled spirit in step (a) is limited only by a given yeast's ability to function therein.

In step (b) of the inventive method, yeast and a fermentable carbohydrate are added to the distilled spirit. Addition of the yeast and the fermentable carbohydrate can be accomplished in any suitable manner. The yeast and the fermentable carbohydrate can be added separately or together. Further, a portion of the fermentable carbohydrate can be added to the distilled spirit, while a portion of the fermentable carbohydrate is added along with the yeast.

In a particularly preferred embodiment of this invention, the yeast is added in the form of a yeast broth which comprises yeast, optionally at least one nutrient and water. Any yeast is suitable for use in the present invention, and many yeasts are commercially available and well-known. Suitable yeast includes, without limitation, Saccharomyces cervisiae and Saccharomyces bayanus. Both naturally occurring yeast as well as genetically engineered yeast can be suitable for use herein. The amount of yeast employed in a given yeast broth should be an amount which can achieve a fermentation reaction which produces the desired level of natural effervescence. One of ordinary skill in this art would readily be able to select a suitable amount of yeast for a given application.

Fermentable carbohydrates suitable for use in the present invention include, without limitation, sugar such as sucrose or fructose, sugar syrups such as glucose or fructose syrup and fruit juices such as grape juice and apple juice (fermented or not), fermentable distilled spirits such as liqueurs and cordials, wines and fortified wines and sake. As used herein, a “fermentable carbohydrate” also includes a fermentable carbohydrate source such as malted or unmalted cereals, worts, beers and mixtures and extracts thereof; another suitable fermentable carbohydrate source includes a non-fermentable carbohydrate coupled with an enzyme or some other activating compound which would convert the non-fermentable carbohydrate into a fermentable carbohydrate. The amount of fermentable carbohydrate employed is dependent upon the overall amount of effervescence or carbonation which is desired. One of ordinary skill in this art would readily be able to select a suitable amount of fermentable carbohydrate for a given application. Typically, the amount of fermentable carbohydrate in the mixture ranges from about 5 g/L to about 300 g/L, more preferably from about 10 g/L to about 24 g/L, prior to the fermenting step. As noted above, the fermentable carbohydrate or a portion thereof may be included in a yeast broth.

A yeast broth may also contain at least one nutrient. Typically, the at least one nutrient is selected from the group consisting of vitamins, minerals, ammonium phosphate, amino acids, and mixtures thereof. The yeast broth may also contain at least one fermentation facilitating ingredient to optimize fermentation conditions. Suitable fermentation facilitating ingredients include, without limitation, buffers (such as trisodium citrate, calcium carbonate and potassium bicarbonate), acidulants (including, but not limited to, organic acids such as lactic acid, malic acid and citric acid and inorganic acids such as phosphoric acid), and fining agents (such as bentonite). In preferred embodiments of the present invention, a nutrient such as ammonium phosphate and/or a buffer such as calcium carbonate is employed. The amount of nutrient (s) and/or fermentation facilitating ingredient(s) contained in the yeast broth is dependent upon what the optimal conditions for fermentation are; ultimately, optimal fermentation conditions are dependent upon factors such as the yeast employed, the alcohol content of the distilled spirit, etc. Further, if a yeast broth is not employed, either or both of the at least one nutrient and the at least one fermentation facilitating ingredient may be added to the mixture as appropriate.

One important fermentation condition is pH. According to the present invention, pH typically ranges from about 2.8 to about 5.5, more preferably from about 3.2 to about 4.5, in the mixture. Suitable acidulants and buffers may be employed so as to maintain a pH within a range in which the yeast can most effectively function and fermentation can efficiently proceed.

Finally, unless using a dried yeast, the yeast broth would contain a dilutant such as water or any other liquid suitable for use in a beverage (alcoholic or non-alcoholic). The amount of dilutant in the yeast broth can vary greatly. For example, an amount of water can range anywhere from an amount just sufficient to serve as a matrix for the other yeast broth components to an amount sufficient to dilute a distilled spirit having more than about 30% alcohol by volume. In other words, a very dilute yeast broth can be employed in such a way that steps (a) and (b) of the inventive method can be performed simultaneously, i.e., a distilled spirit with the appropriate alcohol content can be provided by diluting the spirit with the dilutant, e.g., water, contained in the added yeast broth.

Step (c) of the present invention is carried out for a period of time and at a temperature sufficient to allow the fermentation to progress so as to develop the desired amount of carbonation. In some instances, fermentation is allowed to progress until completion; in others, fermentation is stopped once a desired amount of carbonation is achieved. In certain preferred embodiments of this invention, the period of time ranges from about 1 day to about 2 months, more preferably from about 2 days to about 16 days and most preferably from about 6 days to 14 days. In certain preferred embodiments of this invention, the temperature ranges from about 5° C. to about 40° C., more preferably from about 10° C. to about 25° C. and most preferably from about 12° C. to about 20° C. Step (c) may be carried out in any sealed container such as individual bottles or containers, in a pressurized tank (typically with a generated pressure of up to about 10 bar, more preferably from about 1 to about 8 bar, most preferably from about 0 to about 6 bar), e.g., a keg, or in any other receptacle suitable for such a purpose.

Optional steps for the present inventive method include aging the mixture, removing the yeast, dosing an amount of liquid to the alcoholic beverage having natural effervescence, adding a gas to the alcoholic beverage, and/or achieving a desired overall flavor by combining the inventive alcoholic beverage having natural effervescence with at least one additional beverage ingredient (alcoholic or non-alcoholic) or flavor compound. Any optional aging step may be carried out prior to any optional yeast removal step so as to allow for the development of yeast characteristics. The optional yeast removal step may comprise any suitable means for separating the yeast (and any other sediment) from the finished product. Such suitable means include, without limitation, riddling, fining, centrifugation, degorging, filtration and combinations thereof.

An optional step in the inventive method of the present invention is dosing an amount of liquid to the alcoholic beverage having natural effervescence. In other words, after the fermentation step, an amount of liquid may be added to the alcoholic beverage. Preferably, this addition would take place after any other additional steps have been completed. Any liquid suitable for use in a beverage may be used, including, without limitation, typical alcoholic beverage ingredients and non-alcoholic beverage ingredients. The liquid may be used for a variety of purposes such as replacing liquid which was removed by virtue of other steps, i.e., degorging, creating a desired flavor profile, creating a desired color, adjusting the alcoholic content, etc.

An optional step in the inventive method of the present invention is adding a gas to the alcoholic beverage. The added gas can supplement the natural effervescence achieved by the inventive method. Suitable gases include, without limitation, carbon dioxide, nitrogen and mixtures thereof. The gas may be added by any suitable means and at any suitable point in the inventive method, e.g., before or after the fermentation.

The finished product of the present inventive method can have any degree of natural effervescence, though the amount of natural effervescence typically ranges from about 2 g/L to about 14 g/L CO₂. Likewise, the alcohol content of the finished alcoholic beverage varies widely, given the starting alcohol strength and amount of fermentable material employed. It is also worthwhile to note that the fermentation process employed in the present invention results in an increase in overall alcoholic content; the skilled artisan would readily understand this when designing a given naturally carbonated distilled spirit.

A particularly preferred embodiment of the present inventive method is directed to a method for preparing an alcoholic beverage having natural effervescence, said method comprising the steps of: (a) providing a distilled spirit having no more than about 100% alcohol by volume; (b) adding a yeast broth, said yeast broth comprising yeast, a fermentable carbohydrate, optionally at least one nutrient and water, to the distilled spirit to obtain a mixture having no more than about 30% alcohol by volume; and (c) fermenting the mixture to provide the alcoholic beverage having natural effervescence. All of the details for this embodiment are the same as those set forth above.

A second embodiment of the present invention is directed to a naturally carbonated distilled spirit produced using the method of the present invention. The naturally carbonated distilled spirit can have any degree of natural effervescence, though the amount of natural effervescence typically ranges from about 2 g/L to about 14 g/L CO₂. Likewise, the alcohol content of the naturally carbonated distilled spirit varies widely, given the potential for dosing noted above. It should be apparent that a naturally carbonated distilled spirit according to the second embodiment of the invention may be a combination of a naturally carbonated distilled spirit produced in accordance with the method of this invention and a non-carbonated distilled spirit.

An additional embodiment of the present invention is directed to a method for preparing an alcoholic beverage having natural effervescence, said method comprising the steps of: (a) providing a distilled spirit; (b) adding a microorganism to the distilled spirit to obtain a mixture; and (c) fermenting the mixture to provide the alcoholic beverage having natural effervescence. In addition to yeast, microorganisms such as bacteria can be employed in the inventive secondary fermentation. For example, the secondary fermentation can be malolactic fermentation accomplished via a bacteria such as Leuconostoc oenos. As would be readily appreciated by one of ordinary skill in this art, appropriate fermentation facilitating ingredients (as described above) would typically also be used. Additional process steps for this embodiment are similar to those noted above with regard to the first embodiment of the invention, i.e., aging, dosing, adding a gas, combining with at least one additional beverage ingredient or flavour compound. A further embodiment of the present invention is directed to an alcoholic beverage having natural effervescence made in accordance with the method noted above.

Specific embodiments of the invention will now be demonstrated by reference to the following examples. It should be understood that these examples are disclosed solely by way of illustrating the invention and should not be taken in any way to limit the scope of the present invention.

### EXAMPLE 1

Gin (0.1 L) having 80% alcohol by volume was naturally carbonated by adding a yeast broth having the composition set forth in Table 1 below.

| ingredient | Amount | |
|---|---|---|
| Sugar | 25 | g |
| Acidulants | 2.5 | g |
| diammonium phosphate | 0.1 | g |
| Yeast | 0.001 | g |
| carbonate buffers | 0.0014 | g |
| fining agent | 0.9 | g |
| Water | Q.S. to 0.9 | L |

The mixture was bottled and allowed to ferment for 14 days at 12° C. to produce gin with natural effervescence. The gin was then dosed with appropriate ingredients to customize the flavor profile.

### EXAMPLE 2

Vodka (0.178 L) having 45% alcohol by volume was naturally carbonated by adding a yeast broth having the composition set forth in Table 2 below.

| ingredient | Amount | |
|---|---|---|
| Sugar | 25 | g |
| Acidulants | 2.54 | g |
| diammonium phosphate | 0.1 | g |
| Yeast | 0.001 | g |
| carbonate buffers | 0.0014 | g |
| amino acid | 0.1 | g |
| fining agent | 0.9 | g |
| Water | Q.S. to 0.822 | L |

The mixture was bottled and allowed to ferment for 14 days at 12° C. to produce vodka with natural effervescence. The vodka was then dosed with appropriate ingredients to customize the flavor profile.

### EXAMPLE 3

Whisky (0.123 L) having 65% alcohol by volume was naturally carbonated by adding a yeast broth having the composition set forth in Table 3 below.

| ingredient | Amount | |
|---|---|---|
| Sugar | 25 | g |
| Acidulants | 2.53 | g |
| Diammonium phosphate | 0.2 | g |
| Yeast | 0.001 | g |
| carbonate buffers | 0.0018 | g |
| amino acid | 0.1 | g |
| fining agent | 0.9 | g |
| Water | Q.S. to 0.877 | L |

The mixture was allowed to ferment in a pressurized tank for 14 days at 12° C. to produce whisky with natural effervescence. The whiskey was then dosed with appropriate ingredients to customize the flavor profile.

### EXAMPLE 4

Gin (75.3 ml GNS with 96% alcohol by volume and 9.46 gin high flavor with 80% alcohol by volume) was naturally carbonated by adding a yeast broth having the composition set forth in Table 4 below.

| ingredient | Amount | |
|---|---|---|
| Sugar | 25 | g |
| Acidulants | 2.41 | g |
| diammonium phosphate | 0.1 | g |
| Yeast | 1 | g |
| carbonate buffers | 1.4 | g |
| fining agent | 0.03 | g |
| Water | Q.S. to 915.24 | ml |

The mixture was bottled and allowed to ferment for 14 days at 12° C. to produce gin with natural effervescence. The gin was then dosed with appropriate ingredients to customize the flavor profile.

### EXAMPLE 5

Vodka (237.5 ml) having 40% alcohol by volume was naturally carbonated by adding a yeast broth having the composition set forth in Table 5 below.

| ingredient | Amount | |
|---|---|---|
| Sugar | 25 | g |
| Acidulants | 2.41 | g |
| diammonium phosphate | 0.1 | g |
| Yeast | 1 | g |
| carbonate buffers | 1.4 | g |
| fining agent | 0.03 | g |
| Water | Q.S. to 762.5 | ml |

The mixture was bottled and allowed to ferment for 14 days at 12° C. to produce vodka with natural effervescence. The vodka was then dosed with appropriate ingredients to customize the flavor profile.

### EXAMPLE 6

Vodka (50 ml) having 40% alcohol by volume was naturally carbonated by adding a yeast broth having the composition set forth in Table 6 below.

| ingredient | Amount | |
|---|---|---|
| Wort | 950 | ml |
| Nutrient | 0.1 | g |
| Yeast | 1 | g |

The mixture was allowed to ferment for 14 days at 20° C. to produce a naturally carbonated spirit drink at approximately 6% alcohol by volume. The vodka drink was then dosed with appropriate ingredients to customize the flavor profile.

### EXAMPLE 7

Vodka (50 ml) having 40% alcohol by volume was naturally carbonated by adding a yeast broth having the composition set forth in Table 7 below.

| ingredient | Amount | |
|---|---|---|
| Beer (4% alcohol by volume) | 950 | ml |
| Sugar | 20 | g |
| Nutrient | 0.1 | g |
| Yeast | 1 | g |

The mixture was allowed to ferment for 14 days at 17° C. to produce a naturally carbonated spirit drink at around 7% alcohol by volume. The vodka drink was then dosed with appropriate ingredients to customize the flavor profile.

### EXAMPLE 8

Vodka (250 ml) having 40% alcohol by volume was naturally carbonated by adding a yeast broth having the composition set forth in Table 8 below.

| ingredient | Amount | |
|---|---|---|
| wine (about 10% alcohol by | 200 | ml |
| volume) | | |
| Sugar | 20 | g |
| Nutrient | 0.1 | g |
| Yeast | 1 | g |
| Fining agent | 0.9 | g |
| Water | Q.S. to 1 | L (approximately 550 ml) |

The mixture was allowed to ferment for 14 days at 17° C. to produce a naturally carbonated spirit drink at around 13% alcohol by volume. The vodka drink was then dosed with appropriate ingredients to customize the flavor profile.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A method for preparing an alcoholic beverage having natural effervescence, said method comprising the steps of:
(a) providing a distilled spirit having no more than about 30% alcohol by volume;
(b) adding yeast and a fermentable carbohydrate to the distilled spirit to obtain a mixture; and
(c) fermenting the mixture to provide the alcoholic beverage having natural effervescence.

2. The method according to claim 1, wherein step (a) comprises diluting a distilled spirit which having an alcohol by volume ranging from about 0.1% to about 100%.

3. The method according to claim 1, wherein step (a) comprises directly distilling a spirit having no more than about 30% alcohol by volume.

4. The method according to claim 1, wherein the distilled spirit of step (a) has less than about 20% alcohol by volume.

5. The method according to claim 4, wherein the distilled spirit has from about 1% to less than about 20% alcohol by volume.

6. The method according to claim 5, wherein the distilled spirit has from about 3.5% to about 15% alcohol by volume.

7. The method according to claim 6, wherein the distilled spirit has from about 8% to about 12% alcohol by volume.

8. The method according to claim 1, wherein the yeast is provided in the form of a yeast broth which comprises yeast, optionally at least one nutrient, and a dilutant.

9. The method according to claim 8, wherein the yeast broth further comprises the fermentable carbohydrate or a portion thereof.

10. The method according to claim 1, wherein the fermentable carbohydrate is provided in the mixture in an amount effective to achieve a desired degree of natural effervescence.

11. The method according to claim 10, wherein the fermentable carbohydrate is provided in the mixture in an amount ranging from about 5 g/L to about 300 g/L prior to the fermenting step.

12. The method according to claim 8, wherein the at least one nutrient is selected from the group consisting of vitamins, minerals, ammonium phosphate, amino acids, and mixtures thereof.

13. The method according to claim 8, wherein the yeast broth further comprises at least one fermentation facilitating ingredient selected from the group consisting of acidulants, buffers, fining agents, and combinations thereof.

14. The method according to claim 1, wherein the pH of the mixture ranges from about 2.8 to about 5.5.

15. The method according to claim 1, wherein step (c) is carried out for a period ranging from about 1 day to about 2 months.

16. The method according to claim 15, wherein the period ranges from about 2 days to about 16 days.

17. The method according to claim 16, wherein the period ranges from about 6 days to about 14 days.

18. The method according to claim 1, wherein step (c) is carried out at a temperature ranging from about 5° C. to about 40° C.

19. The method according to claim 18, wherein the temperature ranges from about 10° C. to about 25° C.

20. The method according to claim 19, wherein the temperature ranges from about 12° C. to about 20° C.

21. The method according to claim 1, wherein step (c) is carried out in at least one bottle or sealed container.

22. The method according to claim 1, wherein step (c) is carried out in a pressure vessel or pressurized tank.

23. The method according to claim 1, further comprising the step of:
(d) aging the mixture.

24. The method according to claim 1, further comprising the step of:
(e) removing the yeast.

25. The method according to claim 1, further comprising the step of:
(f) dosing an amount of liquid to the alcoholic beverage having natural effervescence.

26. The method according to claim 1, further comprising the step of:
(g) adding a gas to the alcoholic beverage at any time before or after step (c).

27. The method according to claim 1, further comprising the step of:
(h) combining the alcoholic beverage having natural effervescence with at least one additional beverage ingredient or flavor compound.

28. The method according to claim 1, wherein an amount of natural effervescence ranges from about 2 g/L to about 14 g/L CO₂.

29. A naturally carbonated distilled spirit produced using the method of claim 1.

30. A method for preparing an alcoholic beverage having natural effervescence, said method comprising the steps of:
(a) providing a distilled spirit having no more than about 100% alcohol by volume;
(b) adding a yeast broth, said yeast broth comprising yeast, a fermentable carbohydrate, optionally at least one nutrient and a dilutant, to the distilled spirit to obtain a mixture having no more than about 30% alcohol by volume; and
(c) fermenting the mixture to provide the alcoholic beverage having natural effervescence.

31. A naturally carbonated distilled spirit produced using the method of claim 30.

32. A method for preparing an alcoholic beverage having natural effervescence, said method comprising the steps of:
(a) providing a distilled spirit;
(b) adding a microorganism to the distilled spirit to obtain a mixture; and
(c) fermenting the mixture to provide the alcoholic beverage having natural effervescence.

33. A naturally carbonated distilled spirit produced using the method of claim 32.
